(19) United States
(12) Patent Application Publication
(10) Pub. No.: US 2024/0104133 A1
(43) Pub. Date: Mar. 28, 2024

(54) IMAGE RETRIEVAL APPARATUS, IMAGE RETRIEVAL METHOD, AND NON-TRANSITORY STORAGE MEDIUM

(71) Applicant: NEC Corporation, Tokyo (JP)

(72) Inventors: Tingting Dong, Tokyo (JP); Noboru Yoshida, Tokyo (JP)

(73) Assignee: NEC Corporation, Tokyo (JP)

(21) Appl. No.: 18/233,644

(22) Filed: Aug. 14, 2023

(30) Foreign Application Priority Data
Sep. 22, 2022 (JP) 2022-151024

(51) Int. Cl. G06F 16/532; G06F 16/538

(52) U.S. Cl. CPC G06F 16/532; G06F 16/538

(57) ABSTRACT

In order to enable a user to suitably set a search query, the present invention provides an image retrieval apparatus 10 including: an item value acceptance unit 11 accepting a user input specifying an item value of at least one item in a plurality of items included in a personal attribute; a selection unit 12 selecting a plurality of standard images related to the specified item value from among a plurality of images stored in a storage unit 16; a standard image acceptance unit 13 outputting a plurality of the standard images and accepting a user input specifying one standard image from among the standard images; a generation unit 14 generating a search query, based on a specification result of the standard image; and a retrieval unit 15 performing image retrieval by using the search query.

This application is based upon and claims the benefit of priority from Japanese patent application No. 2022-151024 filed on Sep. 22, 2022, the disclosure of which is incorporated herein in its entirety by reference.

### TECHNICAL FIELD

The present invention relates to an image retrieval apparatus, an image retrieval method, and a program.

### BACKGROUND ART

Technologies related to the present invention are disclosed in International Application Publication No. WO 2018/159095 (Patent Document 1) and Japanese Translation of PCT International Application Publication No. 2016-504656 (Patent Document 2).

Patent Document 1 discloses processing of generating a first query, based on a user input, retrieving images, based on the first query, estimating relationships among a plurality of images selected by a predetermined operation out of images hit by the retrieval, generating a second query, based on the estimated relationships, and retrieving an image, based on the second query.

Patent Document 2 discloses a technology for computing an attribute score indicating reliability of an attribute and performing image retrieval, based on the attribute score.

### DISCLOSURE OF THE INVENTION

In image retrieval based on a personal attribute, use of item values (such as male, female, thirties, and forties) of a wide variety of items (such as gender, age, clothing, and a pose) included in the personal attribute as a search query enables high-precision retrieval of a desired image (an image including a target person). Then, performing image retrieval by further using information “a certainty factor of each item value” enables higher precision retrieval of a desired image. “A certainty factor of each item value” is a value computed by a computer through image analysis and indicates a degree of certainty that a person included in an image has an attribute including the item value.

Examples of search query setting include a method of directly setting an item value and the like by a user. Specifically, a user sets various item values, a logical operator connecting the item values, and the like, such as “male and thirties and checked shirt and sitting pose.” Then, when image retrieval is performed by further using “a certainty factor of an item value of each item,” the user further sets a certainty factor for each item value, such as “male (1.0) and thirties (0.8) and checked shirt (0.7) and sitting pose (0.9).” A numerical value in a parenthesis indicates a certainty factor of each item value.

In an example of a user thus setting not only item values but also a certainty factor of each item value as a search query, there is an issue that it is difficult for the user to set suitable certainty factors. A user unfamiliar with a certainty factor of an item value cannot recognize the type of image to be retrieved as a consequence of setting a certain certainty factor to each item value. Naturally, precision of image retrieval is degraded without suitable setting of certainty factors.

Note that while a case of performing image retrieval by using information being “a certainty factor of an item value of each item” in addition to “an item value of each item” is described as an example, a similar issue may occur when performing image retrieval by using another type of information in place of “a certainty factor of an item value of each item.” In other words, a user unfamiliar with the other type of information cannot recognize the type of image to be retrieved as a consequence of setting a certain value.

The technology described in Patent Document 1 does not assume use of information such as a certainty factor and a reliability level in image retrieval. The technology described in Patent Document 2 performs image retrieval, based on an attribute score indicating reliability of an attribute; however, the attribute score is not directly set by a user. Therefore, neither of Patent Documents 1 and 2 discloses the aforementioned issue and a solution thereto.

An example of an object of the present invention is to, in view of the aforementioned issue, provide an image retrieval apparatus, an image retrieval method, and a program that resolve the issue of enabling a user to suitably set a search query.

According to an aspect of the present invention, an image retrieval apparatus including:
an item value acceptance unit that accepts a user input specifying an item value of at least one item in a plurality of the items included in a personal attribute;
a selection unit that selects a plurality of standard images related to the specified item value from among a plurality of images stored in a storage unit;
a standard image acceptance unit that outputs a plurality of the standard images and accepts a user input specifying the one standard image from among the standard images;
a generation unit that generates a search query, based on a specification result of the standard image; and
a retrieval unit that performs image retrieval by using the search query is provided.

According to an aspect of the present invention, an image retrieval method including, by at least one computer:
accepting a user input specifying an item value of at least one item in a plurality of the items included in a personal attribute;
selecting a plurality of standard images related to the specified item value from among a plurality of images stored in a storage unit;
outputting a plurality of the standard images and accepting a user input specifying the one standard image from among the standard images;
generating a search query, based on a specification result of the standard image; and
performing image retrieval by using the search query is provided.

According to an aspect of the present invention, a program causing a computer to function as:
an item value acceptance unit that accepts a user input specifying an item value of at least one item in a plurality of the items included in a personal attribute;
a selection unit that selects a plurality of standard images related to the specified item value from among a plurality of images stored in a storage unit;
a standard image acceptance unit that outputs a plurality of the standard images and accepts a user input specifying the one standard image from among the standard images;
a generation unit that generates a search query, based on a specification result of the standard image; and
a retrieval unit that performs image retrieval by using the search query is provided.

According to the aspects of the present invention, an image retrieval apparatus, an image retrieval method, and a program that resolve the issue of enabling a user to suitably set a search query are provided.

### BRIEF DESCRIPTION OF THE DRAWINGS

The aforementioned object, and other objects, features, and advantages will become more apparent by the following preferred example embodiments and accompanying drawings.

FIG. 1 is a diagram illustrating an example of a functional block diagram of an image retrieval apparatus.

FIG. 2 is a diagram schematically illustrating an example of information output by an image retrieval apparatus.

FIG. 3 is a diagram illustrating an example of a hardware configuration of the image retrieval apparatus.

FIG. 4 is a diagram schematically illustrating an example of information processed by the image retrieval apparatus.

FIG. 5 is a flowchart illustrating an example of a flow of processing in the image retrieval apparatus.

FIG. 6 is a diagram schematically illustrating another example of information output by an image retrieval apparatus.

FIG. 7 is a diagram schematically illustrating another example of information output by an image retrieval apparatus.

FIG. 8 is a diagram schematically illustrating another example of information output by an image retrieval apparatus.

FIG. 9 is a diagram schematically illustrating another example of information output by the image retrieval apparatus.

FIG. 10 is a flowchart illustrating another example of a flow of processing in an image retrieval apparatus.

### DESCRIPTION OF EMBODIMENTS

Example embodiments of the present invention will be described below by using drawings. Note that in every drawing, similar components are given similar signs, and description thereof is omitted as appropriate.

### First Example Embodiment

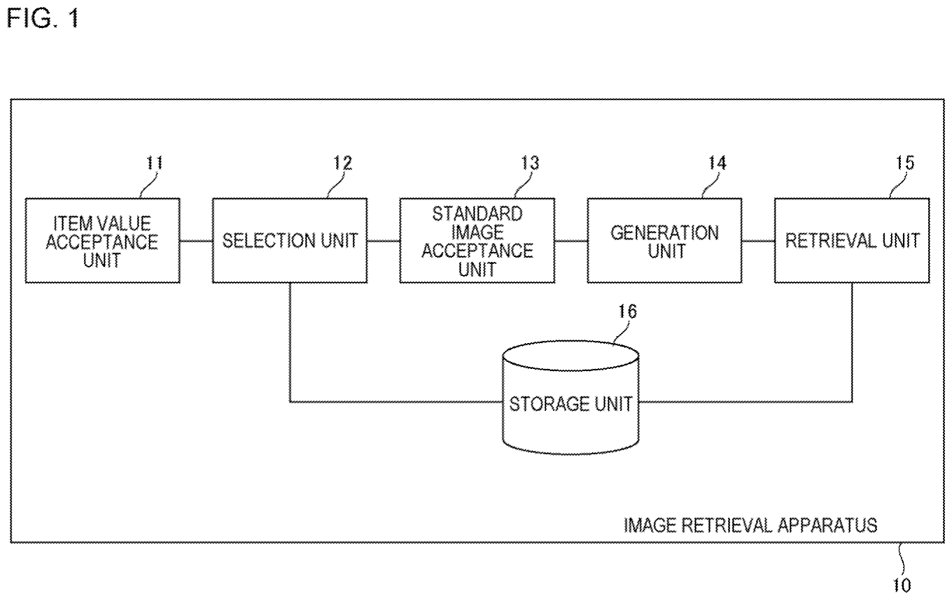

FIG. 1 is a functional block diagram illustrating an overview of an image retrieval apparatus 10 according to a first example embodiment. The image retrieval apparatus 10 includes an item value acceptance unit 11, a selection unit 12, a standard image acceptance unit 13, a generation unit 14, a retrieval unit 15, and a storage unit 16. Note that the image retrieval apparatus 10 may not include the storage unit 16. In this case, an external apparatus configured to be able to communicate with the image retrieval apparatus 10 includes the storage unit 16.

The item value acceptance unit 11 accepts a user input specifying an item value of at least one item in a plurality of items included in a personal attribute. The selection unit 12 selects a plurality of standard images related to a specified item value from among a plurality of images stored in the storage unit 16. The standard image acceptance unit 13 outputs a plurality of standard images and accepts a user input specifying one standard image from among the standard images. The generation unit 14 generates a search query, based on a specification result of a standard image. The retrieval unit 15 performs image retrieval by using a search query. Specifically, the retrieval unit 15 retrieves a predetermined target image indicated by a search query from among reference images stored in the storage unit 16.

The image retrieval apparatus 10 with such a configuration resolves the issue of enabling a user to suitably set a search query.

### Second Example Embodiment

### Overview

An image retrieval apparatus 10 according to the present example embodiment is a more tangible form of the image retrieval apparatus 10 according to the first example embodiment.

The image retrieval apparatus 10 according to the present example embodiment performs image retrieval by using a search query including item values of a plurality of items included in a personal attribute and a certainty factor of each item value (may hereinafter be simply referred to as a “certainty factor”). An example of such a search query is “male (1.0) and thirties (0.8) and checked shirt (0.7) and sitting pose (0.9).” In the search query, male, thirties, checked shirt, and sitting pose are item values and a numerical value in a parenthesis indicates a certainty factor of each item value.

Then, the image retrieval apparatus 10 accepts a setting of such a search query from a user. Specifically, the user determines item values to be included in a search query and determines a certainty factor of each item value. However, setting a certainty factor of each item value is not easy work for a user. A user unfamiliar with a certainty factor of an item value cannot recognize the type of image to be retrieved as a consequence of setting a certain certainty factor to each item value.

Then, the image retrieval apparatus 10 has a function of enabling a user to suitably set a certainty factor of each item value.

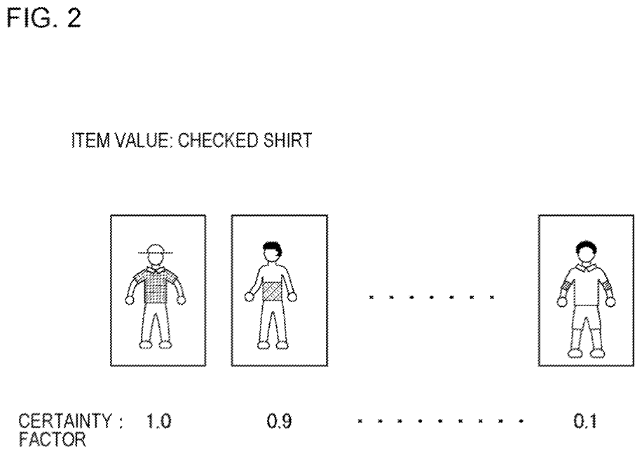

Specifically, when accepting an input specifying an item value from a user, the image retrieval apparatus 10 selects N patterns of standard images for which certainty factors of the specified item value satisfy first to N-th conditions, respectively, from among a plurality of previously prepared images and provides the selected standard images to the user. For example, when “checked shirt” is specified as an item value, the image retrieval apparatus 10 selects a plurality of standard images with various variations in a certainty factor of “checked shirt” as illustrated in FIG. 2 and provides the selected standard images to the user.

The user selects a standard image indicating a checked shirt close to an image which he/she has in mind from among the plurality of provided standard images. Then, for example, the image retrieval apparatus 10 includes a certainty factor associated with the selected standard image into a search query as a certainty factor of the item value.

Such an image retrieval apparatus 10 enables a user to suitably set “a certainty factor of an item value” included in a search query. A configuration of the image retrieval apparatus 10 will be described in detail below.

### Hardware Configuration

Next, an example of a hardware configuration of the image retrieval apparatus 10 will be described. Each functional unit in the image retrieval apparatus 10 is provided by any combination of hardware and software centered on a central processing unit (CPU), a memory, a program loaded into the memory, a storage unit storing the program, such as a hard disk [capable of storing not only a program previously stored in the shipping stage of the apparatus but also a program downloaded from a storage medium such as a compact disc (CD) or a server on the Internet], and a network connection interface that are included in any computer. Then, it may be understood by a person skilled in the art that various modifications to the providing method and the apparatus can be made.

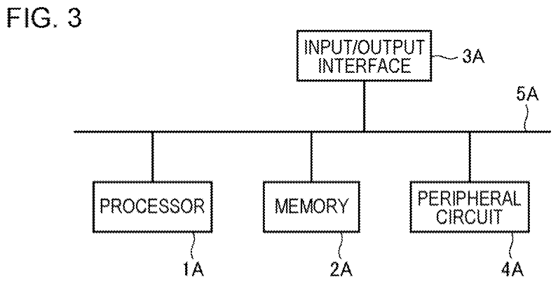

FIG. 3 is a block diagram illustrating a hardware configuration of the image retrieval apparatus 10. As illustrated in FIG. 3, the image retrieval apparatus 10 includes a processor 1A, a memory 2A, an input-output interface 3A, a peripheral circuit 4A, and a bus 5A. Various modules are included in the peripheral circuit 4A. The image retrieval apparatus 10 may not include the peripheral circuit 4A. Note that the image retrieval apparatus 10 may be configured with a plurality of physically and/or logically separate apparatuses. In this case, each of the plurality of apparatuses may include the aforementioned hardware configuration.

The bus 5A is a data transmission channel for the processor 1A, the memory 2A, the peripheral circuit 4A, and the input-output interface 3A to transmit and receive data to and from each other. Examples of the processor 1A include arithmetic processing units such as a CPU and a graphics processing unit (GPU). Examples of the memory 2A include memories such as a random-access memory (RAM) and a read-only memory (ROM). The input-output interface 3A includes an interface for acquiring information from an input apparatus, an external apparatus, an external server, an external sensor, a camera, and the like, and an interface for outputting information to an output apparatus, the external apparatus, the external server, and the like. Examples of the input apparatus include a keyboard, a mouse, a microphone, a physical button, and a touch panel. Examples of the output apparatus include a display, a speaker, a printer, and a mailer. The processor 1A issues an instruction to each module and can perform an operation, based on the operation result by the module.

### Functional Configuration

Next, a functional configuration of the image retrieval apparatus 10 according to the present example embodiment will be described in detail. FIG. 1 illustrates an example of a functional block diagram of the image retrieval apparatus 10. As illustrated, the image retrieval apparatus 10 includes an item value acceptance unit 11, a selection unit 12, a standard image acceptance unit 13, a generation unit 14, a retrieval unit 15, and a storage unit 16. Note that the image retrieval apparatus 10 may not include the storage unit 16. In this case, an external apparatus configured to be able to communicate with the image retrieval apparatus 10 includes the storage unit 16.

The item value acceptance unit 11 accepts a user input specifying an item value of at least one item out of a plurality of items included in a personal attribute.

Examples of a plurality of items included in a personal attribute include gender, an age group, a feature value of a face, a feature of clothing, a clothing type, a hair style, whether headwear is worn, whether glasses are worn, whether a mask is worn, a physical constitution, a height, and a pose but are not limited thereto. An item value of each item indicates information which the item may assume. For example, when an item is gender, male and female are item values.

The item value acceptance unit 11 can accept the user input by using any well-known technology. For example, the item value acceptance unit 11 may accept the user input by using a well-known user interface (UI) component.

Examples of information input by the user input include “checked shirt,” “male and thirties and checked shirt,” and “male and thirties and checked shirt and sitting pose.” Note that a user may specify one item value or a plurality of item values, as described in these examples. Then, when specifying a plurality of item values, the user may further specify a logical operator connecting the item values. While only “and” is indicated in the aforementioned examples as a logical operator, other logical operators such as “or” may be specified.

The selection unit 12 selects a plurality of standard images related to an item value specified by a user input accepted by the item value acceptance unit 11 from among a plurality of images stored in the storage unit 16. Specifically, the selection unit 12 selects N patterns of standard images for which certainty factors of the item value specified by the user input accepted by the item value acceptance unit 11 satisfy first to N-th conditions, respectively, from among the plurality of images stored in the storage unit 16. For example, when an item value specified by a user input is “checked shirt,” the selection unit 12 selects N patterns of standard images for which certainty factors of checked shirt satisfy the first to N-th conditions, respectively.

A certainty factor of each item value is a value computed by a computer through image analysis and indicates a degree of certainty that a person included in an image has an attribute including the item value. A method for computing a certainty factor is not limited.

The first to N-th conditions are set in such a way that images with various certainty factors are selected as standard images. When a certainty factor may take on a value between 0 and 1, examples of the conditions to be set include “a first condition: a certainty factor is greater than 0 and equal to or less than X₁,” “a second condition: a certainty factor is greater than X₁ and equal to or less than X₂,” . . . , and “an N-th condition: a certainty factor is greater than X_{N-1} and equal to or less than 1.”

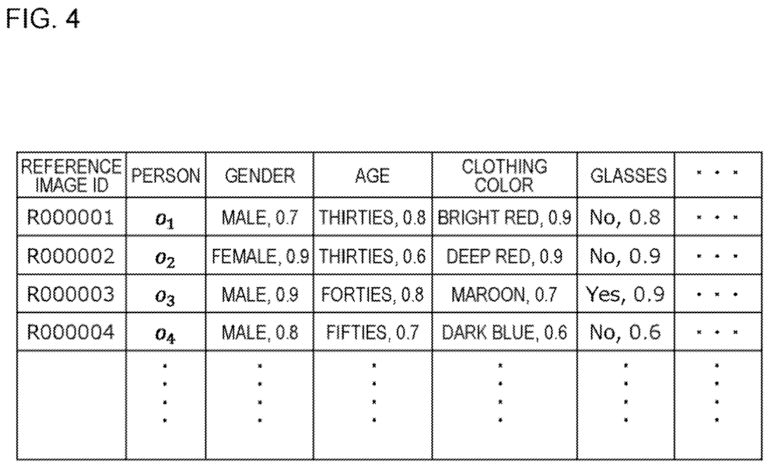

As illustrated in FIG. 4, image analysis is previously performed on each of a plurality of reference images stored in the storage unit 16, and the result is registered. For each reference image, an attribute (item values and certainty factors of a plurality of items) of a person included in the reference image is indicated in the diagram. Note that one item value (an item value with the highest certainty factor) and a certainty factor thereof are indicated in association with one item in the illustrated example. As another example, a plurality of item values and a certainty factor of each item value may be indicated in association with one item. For example, “male, 0.7,” “female, 0.2,” and the like may be registered in association with a person o₁ described in FIG. 4.

By using the information stored in the storage unit 16, the selection unit 12 selects N patterns of standard images for which certainty factors of an item value specified by a user input accepted by the item value acceptance unit 11 satisfy first to N-th conditions, respectively.

Note that when a plurality of item values are specified by a user input accepted by the item value acceptance unit 11, the selection unit 12 can select, for each item value, N patterns of standard images for which certainty factors of the item value satisfy first to N-th conditions, respectively. For example, when a user input accepted by the item value acceptance unit 11 is “male and checked shirt,” the item value acceptance unit 11 selects N patterns of standard images for which certainty factors of “male” satisfy the first to N-th conditions, respectively, and further separately selects N patterns of standard images for which certainty factors of “checked shirt” satisfy the first to N-th conditions, respectively.

Returning to FIG. 1, the standard image acceptance unit 13 outputs a plurality of standard images selected by the selection unit 12 and accepts a user input specifying one standard image from among the standard images.

For example, the standard image acceptance unit 13 displays a plurality of standard images side by side in such a way that the images can be compared with each other, as illustrated in FIG. 2. At this time, a certainty factor of each of the plurality of standard images (a certainty factor of a specified item value) may be indicated in association with the standard image, as illustrated in FIG. 2, or may not be indicated.

Note that when a plurality of item values are specified by a user input accepted by the item value acceptance unit 11, the standard image acceptance unit 13 outputs a plurality of standard images (N patterns of standard images) as illustrated in FIG. 2 for each item value and accepts a user input specifying one standard image from among the standard images.

Returning to FIG. 1, the generation unit 14 generates a search query, based on a specification result of a standard image accepted by the standard image acceptance unit 13. Specifically, the generation unit 14 generates a search query, based on a certainty factor of an item value specified by a user input accepted by the item value acceptance unit 11 in a standard image specified by a user input accepted by the standard image acceptance unit 13. More specifically, the generation unit 14 generates a search query including a combination of “an item value specified by a user input accepted by the item value acceptance unit 11” and “a certainty factor indicated by a condition (one of the aforementioned first to N-th conditions) related to a standard image specified by a user input accepted by the standard image acceptance unit 13.”

Note that when a plurality of item values are specified by a user input accepted by the item value acceptance unit 11, the generation unit 14 can generate a search query including a combination of each of the plurality of specified item values and a certainty factor indicated by a condition related to a standard image specified in relation to the item value.

As a result, for example, a search query such as “male (1.0) and thirties (0.8) and checked shirt (0.7) and sitting pose (0.9)” is generated. In the search query, male, thirties, checked shirt, and sitting pose are “item values specified by a user input accepted by the item value acceptance unit 11” and a numerical value in a parenthesis after each item value is “a certainty factor indicated by a condition related to a standard image specified by a user input accepted by the standard image acceptance unit 13.” As described above, a logical operator in the aforementioned search query is set by the user.

“A certainty factor indicated by a condition related to a standard image specified by a user input accepted by the standard image acceptance unit 13” will be described.

As described above, first to N-th conditions are set in such a way that standard images with various certainty factors are selected. When a certainty factor may take on a value between 0 and 1, examples of the conditions to be set include “a first condition: a certainty factor is greater than 0 and equal to or less than X₁,” “a second condition: a certainty factor is greater than X₁ and equal to or less than X₂,” . . . , and “an N-th condition: a certainty factor is greater than X_{N-1} and equal to or less than 1.”. In this case, a certainty factor indicated by a condition related to a standard image specified by a user input is in a certain range. For example, when a condition related to a standard image specified by a user input is the second condition, a certainty factor indicated by the condition is “greater than X₁ and equal to or less than X₂.”

The generation unit 14 can include a predetermined certainty factor within such a certain range of a certainty factor into a search query. For example, the generation unit 14 may employ a maximum value, a minimum value, a median, or the like. In addition, the generation unit 14 may include a certainty factor of a standard image specified by a user input into a search query.

Returning to FIG. 1, the retrieval unit 15 performs image retrieval by using a search query generated by the generation unit 14. Specifically, the retrieval unit 15 performs image retrieval by using a search query including an item value and a certainty factor thereof. While details of the image retrieval are not particularly limited, an example will be described below.

First, as illustrated in FIG. 4, image analysis is previously performed on each of a plurality of reference images stored in the storage unit 16, and the result is registered. For each reference image, an attribute (item values and certainty factors of a plurality of items) of a person included in the reference image is indicated in the diagram. Note that one item value (an item value with the highest certainty factor) and a certainty factor thereof are indicated in association with one item in the illustrated example. As another example, a plurality of item values and a certainty factor of each item value may be indicated in association with one item. For example, “male, 0.7,” “female, 0.2,” and the like may be registered in association with a person o₁ described in FIG. 4.

The retrieval unit 15 retrieves, as a target image, a reference image for which a relation between attribute information as illustrated in FIG. 4 and a search query satisfies a predetermined condition from among a plurality of reference images.

### Example 1 of Predetermined Condition

For example, a predetermined condition is “a degree of similarity between the aforementioned attribute information and a search query is equal to or greater than a threshold value.” While there are various methods for computing a degree of similarity, for example, the method may be provided by computation using a predetermined function.

While details of the function are not particularly limited, for example, the function may be expressed by Equation (1) below.

[Math. 1]

S(o)=Σⱼ₌₁^{m}pⱼ^{q}·pⱼ^{o}·Sim(fⱼ^{q}, fⱼ^{o}) Equation (1)

Note that pⱼ^{q} is a certainty factor of a j-th element included in a search query. When the search query is “male (1.0) and thirties (0.8) and checked shirt (0.7) and sitting pose (0.9),” a first element is “male (1.0),” and a certainty factor of the element is “1.0.”

Note that pⱼ^{o} is a certainty factor of an item value of an item same as the aforementioned “j-th element” included in attribute information of an o-th reference image. When a search query is “male (1.0) and thirties (0.8) and checked shirt (0.7) and sitting pose (0.9)” and j=1, the “j-th element” is “male (1.0),” as described above. Therefore, an item same as the aforementioned “j-th element” is “gender.” From the above, a certainty factor of an item value of the item same as the aforementioned “j(=1)-th” element included in attribute information of a first reference image (R000001) in the example in FIG. 4 is “0.7.” Then, a certainty factor of an item value of an item same as the aforementioned “j(=1)-th element included in attribute information of a second reference image (R000002) in the example in FIG. 4 is “0.9.”

Sim(fⱼ^{q}, fⱼ^{o}) is a degree of similarity between an item value of a j-th element included in a search query and an item value of an item same as the aforementioned “j-th element” included in attribute information of an o-th reference image. A degree of similarity is computed by any method.

### Example 2 of Predetermined Condition

A predetermined condition is defined by using an item value and a certainty factor that are included in a search query. For example, when item values indicated by a search query are p₁ to pₙ (where n is an integer equal to or greater than 2) and certainty factors of the item values are q₁ to qₙ, respectively, a predetermined condition is “a certainty factor of p₁ is equal to or greater than r₁, a certainty factor of p₂ is equal to or greater than r₂, and a certainty factor of pₙ is equal to or greater than rₙ.” Note that r₁ to rₙ are determined based on q₁ to qₙ, respectively. For example, q₁ to qₙ may be set to r₁ to rₙ, respectively. In addition, r₁ to rₙ may be computed by a predetermined function with q₁ to qₙ as inputs. For example, r₁ to rₙ may be set to values acquired by adding a predetermined value to q₁ to qₙ, respectively, or values acquired by subtracting a predetermined value from q₁ to qₙ, respectively.

For example, when a search query is “male (1.0) and thirties (0.8) and checked shirt (0.7) and sitting pose (0.9),” an example of a predetermined condition is “a certainty factor of male is equal to or greater than 1.0, a certainty factor of thirties is equal to or greater than 0.8, a certainty factor of checked shirt is equal to or greater than 0.7, and a certainty factor of sitting pose is equal to or greater than 0.9.”

Note that in the aforementioned predetermined condition, n pieces of “a certainty factor of pₘ is equal to or greater than rₘ (1≤m≤n)” are connected by “and,” and the condition is that every piece is satisfied. As a modified example, a predetermined ratio of n pieces of “a certainty factor of pₘ is equal to or greater than rₘ (1≤m≤n)” or more is satisfied or a predetermined number of pieces or more are satisfied may be set as the condition.

Further, as for “a certainty factor of pₘ is equal to or greater than rₘ (1≤m≤n)” related to the same item, a condition may be at least one piece is satisfied. For example, when a search query is “male (1.0) and thirties (0.8) and forties (0.6),” an example of a predetermined condition is “at least either condition of a certainty factor of thirties being equal to or greater than 0.8 and a certainty factor of forties being equal to or greater than 0.6 is satisfied and a certainty factor of male is equal to or greater than 1.0.”

Note that the predetermined conditions exemplified herein are strictly examples, and the predetermined condition is not limited thereto.

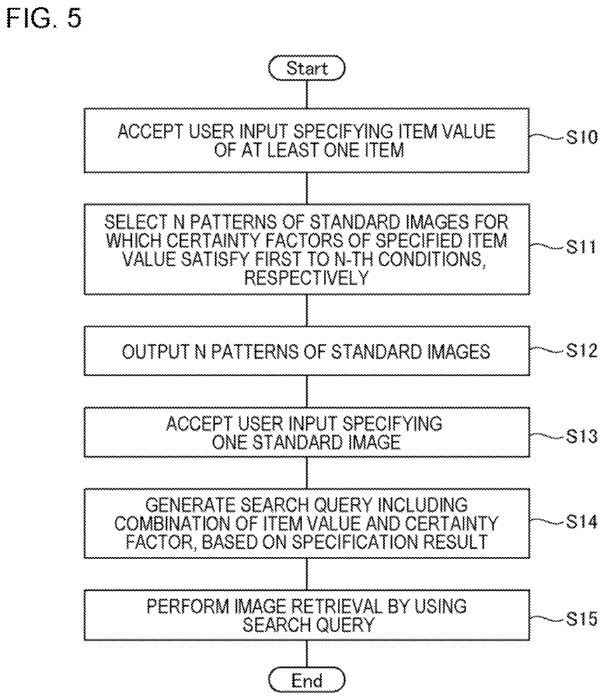

Next, an example of a flow of processing in the image retrieval apparatus 10 will be described by using a flowchart in FIG. 5.

First, the image retrieval apparatus 10 accepts a user input specifying an item value of at least one item in a plurality of items included in a personal attribute (S10). Examples of information input by the user input include “checked shirt,” “male and thirties and checked shirt,” and “male and thirties and checked shirt and sitting pose.” Note that when specifying a plurality of item values as is the case with this example, a user may further specify a logical operator connecting the item values.

Next, the image retrieval apparatus 10 selects N patterns of standard images for which certainty factors of the item value specified in S10 satisfy first to N-th conditions, respectively, from among a plurality of reference images stored in the storage unit 16 (S11). The first to N-th conditions are set in such a way that standard images with various certainty factors are selected. When a certainty factor may take on a value between 0 and 1, examples of the conditions to be set include “a first condition: a certainty factor is greater than 0 and equal to or less than X₁,” “a second condition: a certainty factor is greater than X₁ and equal to or less than X₂,” . . . , and “an N-th condition: a certainty factor is greater than X_{N-1} and equal to or less than 1.”

Next, the image retrieval apparatus 10 outputs the N patterns of standard images selected in S11 (S12). Then, the image retrieval apparatus 10 accepts a user input specifying one standard image from among the N patterns of standard images (S13). For example, the image retrieval apparatus 10 displays a screen as illustrated in FIG. 2 on a display and accepts a user input specifying one standard image from among a plurality of standard images displayed on the screen. Note that when a plurality of item values are specified by the user input accepted in S10, the image retrieval apparatus 10 outputs a plurality of standard images (N patterns of standard images) as illustrated in FIG. 2 for each item value and accepts a user input specifying one standard image from among the standard images.

Next, the image retrieval apparatus 10 generates a search query including a combination of the item value specified by the user input accepted in S10 and a certainty factor indicated by a condition related to the standard image specified by the user input accepted in S13 (S14). When a plurality of item values are specified by the user input accepted in S10, the image retrieval apparatus 10 can generate a search query including a combination of each of the plurality of specified item values and a certainty factor indicated by a condition related to a standard image specified in relation to the item value. As a result, for example, a search query such as “male (1.0) and thirties (0.8) and checked shirt (0.7) and sitting pose (0.9)” is generated. In the search query, male, thirties, checked shirt, and sitting pose are item values specified by the user input accepted in S10, and a numerical value in a parenthesis after each item value is a certainty factor indicated by the aforementioned condition related to a standard image specified by the user input accepted in S13. For example, a logical operator in the aforementioned search query is specified by the user input in S10.

Next, the image retrieval apparatus 10 performs image retrieval by using the search query generated in S14 (S15). While not being illustrated, the image retrieval apparatus 10 can output the retrieval result in S15. For example, the image retrieval apparatus 10 may output a screen on which retrieved target images are displayed in list form as the retrieval result. The retrieval result is output through an output apparatus such as a display, a projector, or a printer.

### Advantageous Effect

The image retrieval apparatus 10 according to the present example embodiment has a function of enabling a user to suitably set a certainty factor of each item value.

Specifically, when accepting an input specifying an item value from a user, the image retrieval apparatus 10 selects N patterns of standard images for which certainty factors of the specified item value satisfy first to N-th conditions, respectively, from among a plurality of previously prepared images and provides the standard images to the user. For example, when “checked shirt” is specified as an item value, the image retrieval apparatus 10 selects a plurality of standard images with various variations of a certainty factor of “checked shirt” and provides the standard images to a user, as illustrated in FIG. 2.

The user selects a standard image indicating a checked shirt close to an image which he/she has in mind from among the plurality of provided standard images. Then, for example, the image retrieval apparatus 10 includes a certainty factor associated with the selected standard image into a search query as a certainty factor of the item value.

Such an image retrieval apparatus 10 enables a user to suitably set a “certainty factor of an item value” included in a search query. As a result, high-precision retrieval of a desired target image from a plurality of reference images is enabled.

### Third Example Embodiment

In the processing of selecting N patterns of standard images for which certainty factors of an item value satisfy first to N-th conditions, respectively, the selection unit 12 according to the second example embodiment selects one image as a standard image of each pattern. Specifically, the selection unit 12 selects one standard image satisfying a first condition (a certainty factor is greater than 0 and equal to or less than X₁) and selects one standard image satisfying a second condition (a certainty factor is greater than X₁ and equal to or less than X₂).

A selection unit 12 according to the present example embodiment selects a plurality of images as standard images of each pattern. Specifically, the selection unit 12 selects a plurality of standard images satisfying the first condition (a certainty factor is greater than 0 and equal to or less than X₁) and selects a plurality of standard images satisfying the second condition (a certainty factor is greater than X₁ and equal to or less than X₂).

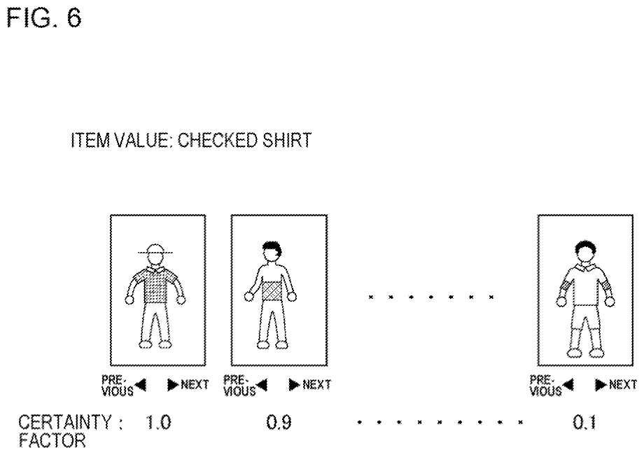

Then, in processing of outputting N patterns of standard images, a standard image acceptance unit 13 outputs a plurality of standard images in association with each pattern. FIG. 6 illustrates an example of the processing. A plurality of patterns of standard images certainty factors of which are different from each other are displayed in FIG. 6. Specifically, a standard image of a pattern with a certainty factor 1.0, a standard image of a pattern with a certainty factor 0.9, a standard image of a pattern with a certainty factor 0.1, and the like are displayed.

Then, a standard image of each pattern can be switched in the example illustrated in FIG. 6. The switching is provided by operating a PREVIOUS button or a NEXT button displayed in association with a standard image of each pattern. For example, when a PREVIOUS button or a NEXT button associated with the standard image for the certainty factor 1.0 is operated, the standard image with the certainty factor 1.0 switches to another standard image with the certainty factor 1.0 in response to the operation.

The remaining configuration of an image retrieval apparatus 10 is similar to those according to the first and second example embodiments.

The image retrieval apparatus 10 according to the present example embodiment provides advantageous effects similar to those of the first and second example embodiments. Further, the image retrieval apparatus 10 according to the present example embodiment can provide a plurality of standard images in association with each pattern to a user. The user can specify a standard image including a person with an attribute close to an image which he/she has in mind from among such abundant standard images. As a result, precision in specification of a standard image by a user can be improved.

### Fourth Example Embodiment

According to the second and third example embodiments, when a plurality of item values are specified by a user input accepted by the item value acceptance unit 11, the selection unit 12 selects, for each item value, N patterns of standard images for which certainty factor of the item value satisfy a first to N-th conditions, respectively. Then, for each item value, the standard image acceptance unit 13 outputs a plurality of standard images (N patterns of standard images) as illustrated in FIG. 2 and accepts a user input specifying one standard image from among the standard images.

On the other hand, according to the present example embodiment, when a plurality of item values are specified by a user input accepted by an item value acceptance unit 11, a selection unit 12 selects, for each combination of a plurality of item values, N patterns of standard images for which combinations of respective certainty factors of the plurality of item values satisfy a first to N-th conditions, respectively. When C item values (where C is two or greater) are specified by a user input accepted by the item value acceptance unit 11, N patterns of standard images are selected for each combination of C or less item values.

A combination of a plurality of item values may be a combination of two item values, a combination of three item values, or a combination of four or more item values. Further, when a plurality of combinations are generated for one user input, the numbers of a plurality of item values constituting the plurality of combinations, respectively, may be different from each other or may be the same.

A combination of a plurality of item values may be specified by a user. For example, when the item value acceptance unit 11 accepts a user input being “male and thirties and checked shirt and horizontally striped trousers and sitting pose,” a user may specify two combinations being “male and thirties and sitting pose” and “checked shirt and horizontally striped trousers” as combinations of a plurality of item values. Further, a user may specify a combination including only one item value. Further, a computer may determine a combination as described above.

The first to N-th conditions are set in such a way that standard images with various combinations of certainty factors are selected. When a certainty factor may take on a value between 0 and 1, examples of the conditions to be set include “a first condition: a certainty factor of a first item value is greater than 0 and equal to or less than X₁, and a certainty factor of a second item value is greater than 0 and equal to or less than X₁,” “a second condition: a certainty factor of the first item value is greater than X₁ and equal to or less than X₂, and a certainty factor of the second item value is greater than 0 and equal to or less than X₁,” “a third condition: a certainty factor of the first item value is greater than X₂ and equal to or less than X₃ and a certainty factor of the second item value is greater than 0 and equal to or less than X₁,” . . . , “an N-th condition: a certainty factor of the first item value is greater than X_{N-1} and equal to or less than 1 and a certainty factor of the second item value is greater than X_{N-1} and equal to or less than 1.” While first to N-th conditions for a combination of two item values are described above, first to N-th conditions for a combination of three or more item values can be similarly set.

Note that the selection unit 12 may select one image as a standard image of each pattern or may select a plurality of images.

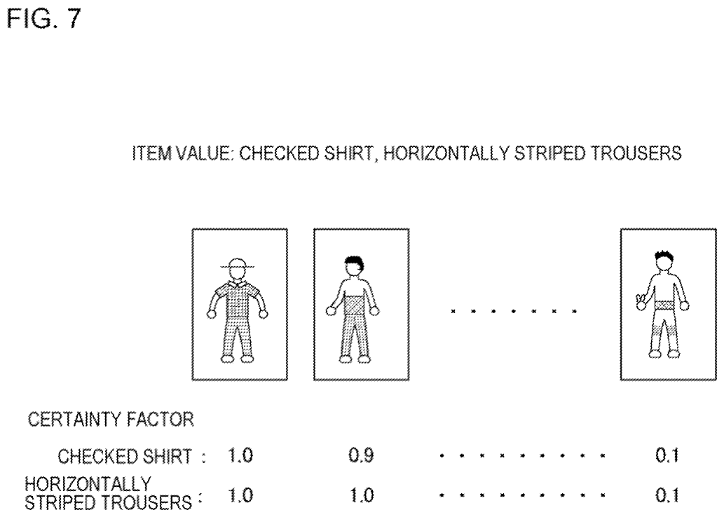

The standard image acceptance unit 13 outputs N patterns of standard images for each combination of a plurality of item values as illustrated in FIG. 7 and accepts a user input specifying one standard image from among the standard images. N patterns of standard images related to a combination of “item value: checked shirt” and “item value: horizontally striped trousers” are illustrated in FIG. 7.

The generation unit 14 generates a search query including a combination of each of a plurality of item values and a certainty factor indicated by a condition related to a standard image specified in relation to each combination of a plurality of item values. For example, when the leftmost standard image is specified by a user from among N patterns of standard images displayed in relation to a combination of “item value: checked shirt” and “item value: horizontally striped trousers” as illustrated in FIG. 7, the generation unit 14 generates a search query including “checked shirt (1.0)” and “horizontally striped trousers (1.0).”

The remaining configuration of an image retrieval apparatus 10 is similar to those according to the first to third example embodiment.

The image retrieval apparatus 10 according to the present example embodiment provides advantageous effects similar to those of the first to third example embodiments. Further, the image retrieval apparatus 10 according to the present example embodiment can provide a plurality of patterns of standard images for each combination of a plurality of item values to a user. Collective processing of item values that may be handled as a set, such as shirt and trousers, enables improved processing efficiency and high-precision specification of a standard image matching an image which a user has in mind.

### Fifth Example Embodiment

A selection unit 12 according to the present example embodiment selects a plurality of patterns of standard images similarly to the aforementioned example embodiment and can select a plurality of patterns of standard images by a more characteristic technique. Details will be described below.

The selection unit 12 is configured in such a way as to be able to practice at least one of the following first to third selection methods. Note that the selection unit 12 may be configured in such a way as to be able to practice a plurality of selection methods among the following first to third selection methods. Then, the selection unit 12 may select a standard image by a method specified by a user.

### First Selection Method

When a plurality of item values are specified by a user input accepted by an item value acceptance unit 11, the selection unit 12 uses, in selection of N patterns of standard images related to a first item value among a plurality of item values, a second item value different from the first item value among the plurality of item values.

Specifically, the selection unit 12 can select images for which a certainty factor of a second item value is equal to or greater than a threshold value, as N patterns of standard images related to a first item value.

For example, when information input by a user input accepted by the item value acceptance unit 11 is “male and checked shirt,” every one of N patterns of standard images satisfying first to N-th conditions related to “male,” respectively, has a certainty factor of “checked shirt” equal to or greater than the threshold value.

Note that when three or more item values are specified by a user input accepted by the item value acceptance unit 11 as is the case in “male and thirties and checked shirt,” every one of N patterns of standard images satisfying first to N-th conditions related to a certain item value, respectively, may have a certainty factor equal to or greater than the threshold value for all remaining item values, may have a certainty factor equal to or greater than the threshold value for a predetermined ratio or more of the remaining item values, or may have a certainty factor equal to or greater than the threshold value for a predetermined number or more of the remaining item values.

Further, when a plurality of standard images are selected for each combination of a plurality of item values as described in the fourth example embodiment, standard images can be similarly selected in such a way that a certainty factor of a remaining item value satisfies the aforementioned condition.

### Second Selection Method

The selection unit 12 can select images not including identical persons or images including identical persons as N patterns of standard images.

The selection unit 12 may make a selection in such a way that none of N patterns of standard images include identical persons. Further, the selection unit 12 may make a selection in such a way that all of N patterns of standard images include identical persons.

Further, the selection unit 12 make a selection in such a way that a predetermined ratio or more of N patterns of standard images do not include identical persons. Further, the selection unit 12 may make a selection in such a way that a predetermined ratio or more of N patterns of standard images include identical persons.

Further, the selection unit 12 may make a selection in such a way that a predetermined number or more of N patterns of standard images do not include identical persons. Further, the selection unit 12 may make a selection in such a way that a predetermined number or more of N patterns of standard images include identical persons.

Whether persons are identical can be determined based on features (such as face information, clothing, a physical constitution, and a body shape) of external appearances of the persons appearing in images.

### Third Selection Method

As N patterns of standard images related to a first item value, the selection unit 12 can select a plurality of images for which item values of other items different from an item to which the first item value belongs are different from each other or identical to each other.

Specifically, when selecting N patterns of standard images related to “male,” the selection unit 12 selects a plurality of standard images for which item values of any items among other items (such as an age group and a feature of clothing) different from “gender” being an item to which “male” belongs are different from each other or identical to each other.

The selection unit 12 may make a selection in such a way that item values of any other items of all of N patterns of standard images are different from each other. Further, the selection unit 12 may make a selection in such a way that item values of any other items of N patterns of standard images are identical to each other.

Further, the selection unit 12 may make a selection in such a way that item values of any other items of a predetermined ratio or more of N patterns of standard images are different from each other. Further, the selection unit 12 may make a selection in such a way that item values of any other items of a predetermined ratio or more of N patterns of standard images are identical to each other.

Further, the selection unit 12 may make a selection in such a way that item values of any other items of a predetermined number or more of N patterns of standard images are different from each other. Further, the selection unit 12 may make a selection in such a way that item values of any other items of predetermined number or more of N patterns of standard images are identical to each other.

The remaining configuration of an image retrieval apparatus 10 is similar to those according to the first to fourth example embodiment.

The image retrieval apparatus 10 according to the present example embodiment provides advantageous effects similar to those of the first to fourth example embodiments. Further, the image retrieval apparatus 10 according to the present example embodiment can select N patterns of standard images by a characteristic technique. As a result, a plurality of standard images suitable for comparison can be selected and be provided to a user.

### Sixth Example Embodiment

An image retrieval apparatus 10 has a function of supporting user work of specifying one standard image from among N displayed patterns of standard images. Specifically, the image retrieval apparatus 10 provides information useful for specifying one standard image to a user. Details will be described below.

A standard image acceptance unit 13 registers a past operation history by a user in a storage apparatus. The operation history indicates a certainty factor of a standard image specified by a user for each item value.

When displaying N patterns of standard images related to a first item value, the standard image acceptance unit 13 determines a certainty factor specified in the past by a user for the first item value, based on the aforementioned operation history. Then, the standard image acceptance unit 13 displays a certainty factor specified in the past by the user for the first item value on a screen displaying N patterns of standard images related to the first item value, as illustrated in FIG. 2. For example, information such as “You have specified a certainty factor ‘0.8’ for ‘checked shirt’ in the past” is displayed. Note that when there are a plurality of past operation histories related to the first item value, a statistical value (such as a mode) of a plurality of certainty factors specified in the past may be provided to the user.

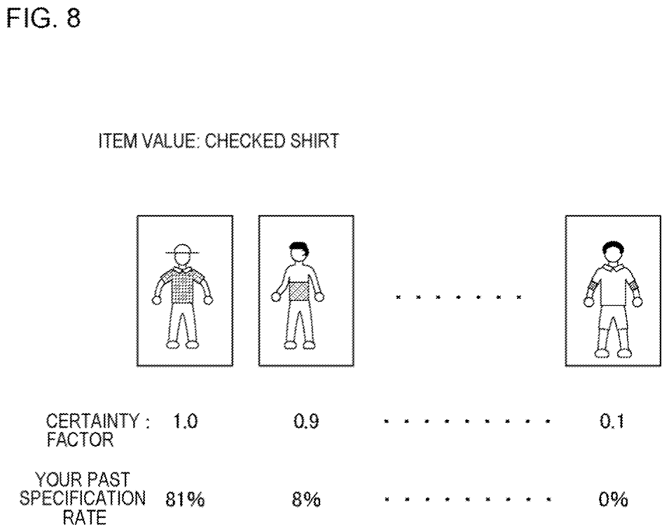

In addition, the standard image acceptance unit 13 may compute and display a past specification rate (specification ratio) of a user for each certainty factor, as illustrated in FIG. 8.

As another example, the standard image acceptance unit 13 may generate and display information as described above, based on an operation history of another user.

Specifically, when displaying N patterns of standard images related to a first item value, the standard image acceptance unit 13 recognizes a certainty factor specified in the past by another user for the first item value, based on the aforementioned operation history. Then, the standard image acceptance unit 13 displays a trend of the certainty factor specified in the past by the another user for the first item value on a screen displaying N patterns of standard images related to the first item value as illustrated in FIG. 2. For example, information such as “a certainty factor ‘0.8’ is frequently specified for ‘checked shirt’” is displayed. Note that when there are past operation histories of a plurality of users related to the first item value, a statistical value (such as a mode) of a plurality of certainty factors specified by the plurality of users may be provided to the user.

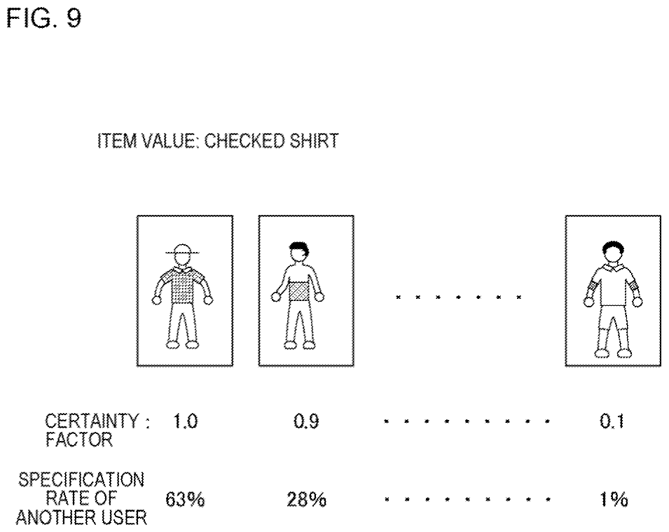

In addition, the standard image acceptance unit 13 may compute and display a specification rate (specification ratio) of another user for each certainty factor, as illustrated in FIG. 9.

Note that when N patterns of standard images are displayed for each combination of a plurality of item values as illustrated in FIG. 7, similar information can be displayed by similar processing.

The remaining configuration of the image retrieval apparatus 10 is similar to those according to the first to fifth example embodiment.

The image retrieval apparatus 10 according to the present example embodiment provides advantageous effects similar to those of the first to fifth example embodiments. Further, the image retrieval apparatus 10 according to the present example embodiment can provide information useful for specification of one standard image to a user. As a result, the user can suitably and promptly specify one standard image.

### Seventh Example Embodiment

The processing according to the aforementioned example embodiment is processing based on the premise that a certainty factor of an item value is not input by a user input accepted by the item value acceptance unit 11. Specifically, information input by a user input accepted by the item value acceptance unit 11 is composed of one or more item values and one or more logical operators such as “checked shirt,” “male and thirties and checked shirt,” and “male and thirties and checked shirt and sitting pose” and does not include certainty factors of the item values.

Examples of a configuration providing such processing include (1) “the item value acceptance unit 11 is configured to accept a user input specifying an item value and a logical operator but is not configured to accept a user input specifying a certainty factor of the item value” and (2) “the item value acceptance unit 11 is configured to accept a user input specifying an item value, a logical operator, and a certainty factor of the item value but is also configured to allow a certainty factor of part of the item values to be left blank.”

A configuration of an image retrieval apparatus 10 according to the present example embodiment is the aforementioned example (2). Specifically, whether a certainty factor of an item value is specified depends on a user, and a certainty factor may or may not be specified. When a certainty factor of every item value is not specified by a user input accepted by an item value acceptance unit 11, the image retrieval apparatus 10 can execute the processing described in the aforementioned example embodiment. Then, when a certainty factor of at least part of item values is specified by a user input accepted by the item value acceptance unit 11, the image retrieval apparatus 10 can execute characteristic processing described below.

As described in the aforementioned example embodiment, the item value acceptance unit 11 accepts a user input specifying at least one item value. Further, the item value acceptance unit 11 can also accept a user input specifying a plurality of item values. In this case, the item value acceptance unit 11 accepts a user input specifying a logical operator connecting the plurality of item values.

Further, the item value acceptance unit 11 can accept a user input specifying, in association with each specified item value, “a certainty factor of the item value” or leaving “a certainty factor of the item value” blank without specifying the certainty factor. When a plurality of item values are specified, whether to specify, for each item value, “a certainty factor of the item value” or leave “a certainty factor of the item value” blank without specifying the certainty factor may be selectable.

Examples of information input by the user input include “checked shirt (certainty factor: blank),” “checked shirt (0.8),” “male (certainty factor: blank) and checked shirt (certainty factor: blank),” “male (0.9) and checked shirt (certainty factor: blank),” and “male (0.9) and checked shirt (0.7).”

A selection unit 12 selects a plurality of standard images by a first technique for an item value for which a certainty factor is not specified and selects a plurality of standard images by a second technique for an item value for which a certainty factor is specified.

In the first technique, the selection unit 12 selects N₁ patterns of standard images for which certainty factors of an item value satisfy first to N₁-th conditions, respectively.

In the second technique, the selection unit 12 selects N₂ patterns of standard images for which certainty factors of an item value satisfy first to N₂-th conditions, respectively.

Note that N₂<N₁. In other words, more patterns of standard images are selected and are provided to a user in the case of a certainty factor not being specified.

The difference between the maximum value and the minimum value of certainty factors (coverage of a certainty factor) of a plurality of standard images selected by the first technique is greater than the difference between the maximum value and the minimum value of certainty factors (coverage of a certainty factor) of a plurality of standard images selected by the second technique. In other words, a plurality of standard images selected by the first technique have wider certainty factor coverage. For example, in the second technique, a plurality of standard images are selected in such a way that a predetermined range around a specified certainty factor is covered. For example, standard images with all certainty factors in a range from (a specified certainty factor−α) to (the specified certainty factor+α) are selected in the second technique. On the other hand, standard images with all certainty factors are selected in a wider range in the first technique. For example, a plurality of standard images may be selected in such a way that the entire range of values which a certainty factor may take on is covered in the first technique.

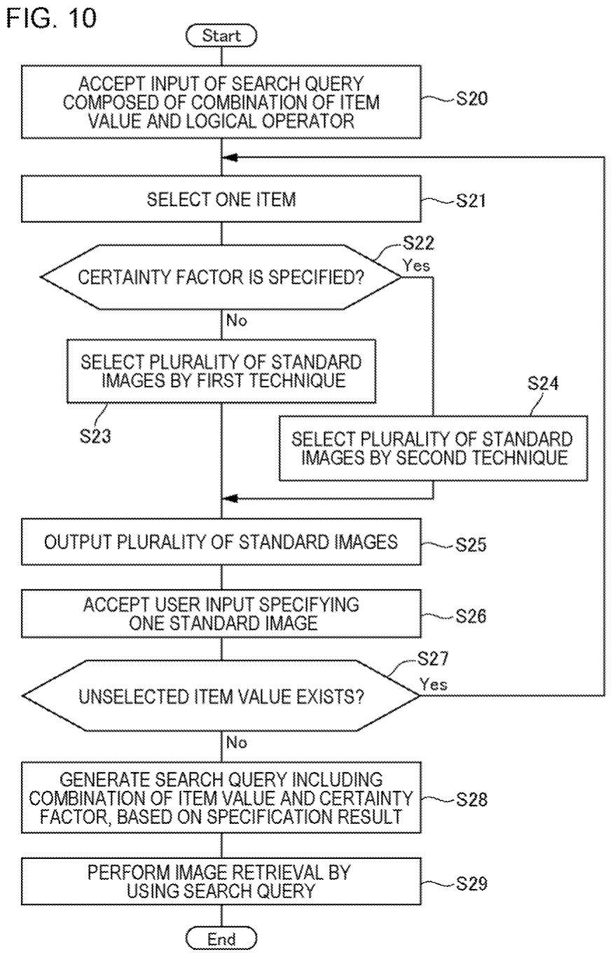

Next, an example of a flow of processing in the image retrieval apparatus 10 will be described by using a flowchart in FIG. 10.

First, the image retrieval apparatus 10 accepts an input of a search query composed of a combination of an item value, a certainty factor, and a logical operator (S20). Note that a certainty factor of an item value may be left blank. Examples of information input by the user input include “checked shirt (certainty factor: blank),” “checked shirt (0.8),” “male (certainty factor: blank) and checked shirt (certainty factor: blank),” “male (0.9) and checked shirt (certainty factor: blank),” and “male (0.9) and checked shirt (0.7).”

Next, the image retrieval apparatus 10 selects one item value from the search query input in S20 (S21). When a certainty factor is not specified in association with the selected item value (No in S22), the image retrieval apparatus 10 selects a plurality of standard images related to the item value by the first technique (S23). On the other hand, when a certainty factor is specified in association with the selected item value (Yes in S22), the image retrieval apparatus 10 selects a plurality of standard images related to the item value by the second technique (S24).

Next, the image retrieval apparatus 10 outputs the plurality of selected standard images to the user (S25) and accepts a user input specifying one standard image from among the standard images (S26).

When an item value not selected in S21 exists in the item values included in the search query input in S20 (Yes in S27), the image retrieval apparatus 10 returns to S21, selects another item value, and performs similar processing.

When an item value not selected in S21 does not exist in the item values included in the search query input in S20 (No in S27), the image retrieval apparatus 10 generates a search query including a combination of an item value specified by the user input accepted in S20 and a certainty factor indicated by a condition related to a standard image specified by the user input accepted in S26 (S28).

Next, the image retrieval apparatus 10 performs image retrieval by using the search query generated in S28 (S29). While not being illustrated, the image retrieval apparatus 10 can output the retrieval result in S29. For example, the image retrieval apparatus 10 may output a screen on which retrieved target images are displayed in list form as the retrieval result. The retrieval result is output through an output apparatus such as a display, a projector, or a printer.

The remaining configuration of the image retrieval apparatus 10 is similar to those according to the first to sixth example embodiment.

The image retrieval apparatus 10 according to the present example embodiment provides advantageous effects similar to those of the first to sixth example embodiments. Further, the image retrieval apparatus 10 according to the present example embodiment can generate a search query by characteristic processing when a user specifies a certainty factor of at least part of item values. Specifically, even when a user specifies a certainty factor, the precision thereof may not be sufficient. Therefore, even when a user specifies a certainty factor, the image retrieval apparatus 10 according to the present example embodiment does not use the information as information for a search query on an as-is basis. Even when a user specifies a certainty factor, the image retrieval apparatus 10 provides a plurality of standard images related to the item value and determines a certainty factor of the item value to be included in a search query, based on a result of specification from among the standard images.

Through such processing, a search query based on an intention of the user can be generated.

Further, when a user specifies a certainty factor, standard images with certainty factors in the neighborhood of the certainty factor are selected and are provided to the user, according to the present example embodiment. Thus, the number of standard images to be processed is reduced, and a processing load on the computer is lightened. Further, the number of standard images to be confirmed by the user is also reduced, and therefore a workload on the user is also lightened.

### MODIFIED EXAMPLES

Modified examples applicable to the first to seventh example embodiments will be described below. The modified examples also provide advantageous effects similar to those of the aforementioned example embodiments.

### Modified Example 1

According to the seventh example embodiment, even when a certainty factor of a certain item value is specified, a plurality of standard images are provided, an input specifying one standard image from among the standard images is accepted, and a certainty factor of the item value to be included in a search query is determined based on the specification result. As a modified example, when a certainty factor of a certain item value is specified, the image retrieval apparatus 10 may not perform selection and provision of a plurality of standard images, acceptance of a user input specifying one standard image, and the like and include the specified certainty factor into a search query on an as-is basis as a certainty factor of the item value. Then, the image retrieval apparatus 10 may perform selection and provision of a plurality of standard images, acceptance of a user input specifying one standard image, and the like only on an item value for which a certainty factor is not specified and determine a certainty factor of the item value.

### Modified Example 2

The generation unit 14 may change an item value to be included into a search query from an item value accepted by the item value acceptance unit 11, based on a result of specification of a standard image accepted by the standard image acceptance unit 13.

For example, it is assumed that the item value acceptance unit 11 accepts information “male and thirties” and the standard image acceptance unit 13 provides a plurality of standard images related to thirties. Then, it is assumed that the standard image acceptance unit 13 accepts a user input specifying a standard image with a certainty factor 0.3. It is further assumed that a certainty factor of forties is 0.8 according to an analysis result of the standard image.

In this case, the generation unit 14 may not include thirties (0.3) into a search query and may instead include forties (0.8) into the search query.

Thus, when a certainty factor C₁ of a first item value of a standard image specified by a user from among a plurality of standard images related to the first item value and a certainty factor C₂ of a second item value of the standard image specified by the user satisfy “C₁<C₂,” the generation unit 14 can include the second item value into a search query in place of the first item value. Note that the first item value and the second item value are values of the same item.

### Modified Example 3

The case of performing image retrieval by using information “a certainty factor of an item value of each item” in addition to “an item value of each item” is described as an example in the aforementioned example embodiment. Similar advantageous effects are provided by similar processing when image retrieval is performed by using another type of information in place of “a certainty factor of an item value of each item.” Specifically, the image retrieval apparatus 10 selects a plurality of standard images including various variations of other types of information, provides the standard images to a user, accepts an input specifying one standard image, and generates a search query, based on the result of specification.

### Modified Example 4

The selection unit 12 selects a standard image from among a plurality of reference images (target images of retrieval by the retrieval unit 15) stored in the storage unit 16 in the aforementioned example embodiment but may select a standard image from among images other than the reference images. Specifically, a plurality of images other than the reference images may be previously stored for standard image selection in the storage unit 16. Then, the selection unit 12 may select a standard image from among the plurality of images for standard image selection.

While the example embodiments of the present invention have been described above with reference to the drawings, the example embodiments are exemplifications of the present invention, and various configurations other than those described above may be employed. The configurations according to the aforementioned example embodiments may be combined or may be partially substituted by another configuration. Further, various modifications may be made to the configurations according to the aforementioned example embodiments without departing from the spirit thereof. Further, the configurations and processing disclosed in the aforementioned example embodiments and the modified examples thereof may be combined.

Further, while a plurality of processes (processing) are described in a sequential order in each of a plurality of flowcharts used in the aforementioned description, the execution order of processes executed in each example embodiment is not limited to the order of description. The order of the illustrated processes may be modified without affecting the contents in each example embodiment. Further, the aforementioned example embodiments may be combined without contradicting each other.

The whole or part of the example embodiments disclosed above may also be described as, but not limited to, the following supplementary notes.

1. An image retrieval apparatus including:
an item value acceptance unit that accepts a user input specifying an item value of at least one item in a plurality of the items included in a personal attribute;
a selection unit that selects a plurality of standard images related to the specified item value from among a plurality of images stored in a storage unit;
a standard image acceptance unit that outputs a plurality of the standard images and accepts a user input specifying the one standard image from among the standard images;
a generation unit that generates a search query, based on a specification result of the standard image; and
a retrieval unit that performs image retrieval by using the search query.
   2. The image retrieval apparatus according to 1, wherein
the generation unit generates the search query, based on a certainty factor of the specified item value in the specified standard image.
   3. The image retrieval apparatus according to 1 or 2, wherein
the selection unit selects N patterns of the standard images for which certainty factors of the specified item value satisfy first to N-th conditions, respectively, from among a plurality of images,
the standard image acceptance unit outputs the N patterns of the standard images and accepts a user input specifying the one standard image from among the standard images, and
the generation unit generates the search query including a combination of the item value and the certainty factor indicated by the condition related to the specified standard image.
   4. The image retrieval apparatus according to 3, wherein,
when a plurality of the item values are specified,
   the selection unit selects, for the each item value, N patterns of the standard images for which certainty factors of the item value satisfy first to N-th conditions, respectively,
   the standard image acceptance unit outputs, for the each item value, the N patterns of the standard images and accepts a user input specifying the one standard image from among the standard images, and
   the generation unit generates the search query including a combination of each of a plurality of the item values and the certainty factor indicated by the condition related to the standard image specified in relation to the each item value.
      5. The image retrieval apparatus according to 3, wherein,
when a plurality of the item values are specified,
   the selection unit selects, for each combination of a plurality of the item values, N patterns of the standard images for which combinations of respective certainty factors of a plurality of the item values satisfy first to N-th conditions, respectively,
   the standard image acceptance unit outputs, for each combination of a plurality of the item values, the N patterns of the standard images and accepts a user input specifying the one standard image from among the standard images, and
   the generation unit generates the search query including a combination of each of a plurality of the item values and the certainty factor indicated by the condition related to the standard image specified in relation to each combination of a plurality of the item values.
      6. The image retrieval apparatus according to any one of 3 to 5, wherein,
when a plurality of the item values are specified, the selection unit uses, in selection of the N patterns of the standard images related to a first item value in a plurality of the item values, a second item value different from the first item value in a plurality of the item values.
   7. The image retrieval apparatus according to 6, wherein
the selection unit selects images for each of which a certainty factor of the second item value is equal to or greater than a threshold value, as the N patterns of the standard images related to the first item value.
   8. The image retrieval apparatus according to any one of 3 to 7, wherein
the selection unit selects images not including identical persons or images including identical persons, as the N patterns of the standard images.
   9. The image retrieval apparatus according to any one of 3 to 8, wherein
the selection unit selects a plurality of images for which the item values of other items different from the item to which a first item value belongs are different from each other or identical to each other, as the N patterns of the standard images related to the first item value.
   10. The image retrieval apparatus according to any one of 3 to 9, wherein
the selection unit selects at least one image as the standard image of a first pattern in the N patterns of the standard images.
   11. An image retrieval method including, by at least one computer:
accepting a user input specifying an item value of at least one item in a plurality of the items included in a personal attribute;
selecting a plurality of standard images related to the specified item value from among a plurality of images stored in a storage unit;
outputting a plurality of the standard images and accepting a user input specifying the one standard image from among the standard images;
generating a search query, based on a specification result of the standard image; and
performing image retrieval by using the search query.
   12. A program causing a computer to function as:
an item value acceptance unit that accepts a user input specifying an item value of at least one item in a plurality of the items included in a personal attribute;
a selection unit that selects a plurality of standard images related to the specified item value from among a plurality of images stored in a storage unit;
a standard image acceptance unit that outputs a plurality of the standard images and accepts a user input specifying the one standard image from among the standard images;
a generation unit that generates a search query, based on a specification result of the standard image; and
a retrieval unit that performs image retrieval by using the search query.

1. An image retrieval apparatus comprising:
at least one memory configured to store one or more instructions; and
at least one processor configured to execute the one or more instructions to:
accept a user input specifying an item value of at least one item in a plurality of the items included in a personal attribute;
select a plurality of standard images related to the specified item value from among a plurality of images stored in storage unit;
output a plurality of the standard images and accept a user input specifying the one standard image from among the standard images;
generate a search query, based on a specification result of the standard image; and
perform image retrieval by using the search query.

2. The image retrieval apparatus according to claim 1, wherein
the processor is further configured to execute the one or more instructions to generate the search query, based on a certainty factor of the specified item value in the specified standard image.

3. The image retrieval apparatus according to claim 1, wherein the processor is further configured to execute the one or more instructions to:
select N patterns of the standard images for which certainty factors of the specified item value satisfy first to N-th conditions, respectively, from among a plurality of images,
output the N patterns of the standard images and accept a user input specifying the one standard image from among the standard images, and
generate the search query including a combination of the item value and the certainty factor indicated by the condition related to the specified standard image.

4. The image retrieval apparatus according to claim 3, wherein the processor is further configured to execute the one or more instructions to:
when a plurality of the item values are specified,
select, for the each item value, N patterns of the standard images for which certainty factors of the item value satisfy first to N-th conditions, respectively,
output, for the each item value, the N patterns of the standard images and accept a user input specifying the one standard image from among the standard images, and
generate the search query including a combination of each of a plurality of the item values and the certainty factor indicated by the condition related to the standard image specified in relation to the each item value.

5. The image retrieval apparatus according to claim 3, wherein processor is further configured to execute the one or more instructions to:
when a plurality of the item values are specified,
select, for each combination of a plurality of the item values, N patterns of the standard images for which combinations of respective certainty factors of a plurality of the item values satisfy first to N-th conditions, respectively,
output, for each combination of a plurality of the item values, the N patterns of the standard images and accept a user input specifying the one standard image from among the standard images, and
generate the search query including a combination of each of a plurality of the item values and the certainty factor indicated by the condition related to the standard image specified in relation to each combination of a plurality of the item values.

6. The image retrieval apparatus according to claim 3, wherein, the processor is further configured to execute the one or more instructions to:
when a plurality of the item values are specified, use, in selection of the N patterns of the standard images related to a first item value in a plurality of the item values, a second item value different from the first item value in a plurality of the item values.

7. The image retrieval apparatus according to claim 6, wherein
the processor is further configured to execute the one or more instructions to select images for each of which a certainty factor of the second item value is equal to or greater than a threshold value, as the N patterns of the standard images related to the first item value.

8. The image retrieval apparatus according to claim 3, wherein
the processor is further configured to execute the one or more instructions to select images not including identical persons or images including identical persons, as the N patterns of the standard images.

9. The image retrieval apparatus according to claim 3, wherein
the processor is further configured to execute the one or more instructions to select a plurality of images for which the item values of other items different from the item to which a first item value belongs are different from each other or identical to each other, as the N patterns of the standard images related to the first item value.

10. The image retrieval apparatus according to claim 3, wherein
the processor is further configured to execute the one or more instructions to select at least one image as the standard image of a first pattern in the N patterns of the standard images.

11. An image retrieval method comprising, by at least one computer:
accepting a user input specifying an item value of at least one item in a plurality of the items included in a personal attribute;
selecting a plurality of standard images related to the specified item value from among a plurality of images stored in storage unit;
outputting a plurality of the standard images and accepting a user input specifying the one standard image from among the standard images;
generating a search query, based on a specification result of the standard image; and
performing image retrieval by using the search query.

12. A non-transitory storage medium storing a program causing a computer to:
accept a user input specifying an item value of at least one item in a plurality of the items included in a personal attribute;
select a plurality of standard images related to the specified item value from among a plurality of images stored in storage unit;
output a plurality of the standard images and accept a user input specifying the one standard image from among the standard images;
generate a search query, based on a specification result of the standard image; and
perform image retrieval by using the search query.
